(19) United States
(12) Patent Application Publication
(10) Pub. No.: US 2017/0373539 A1
(43) Pub. Date: Dec. 28, 2017

(54) SELECTIVE POWER TRANSMITTING ELEMENT USE FOR WIRELESS POWER TRANSFER

(71) Applicant: QUALCOMM Incorporated, San Diego, CA (US)

(72) Inventors: William Henry VON NOVAK, III, San Diego, CA (US); Jen CHEN, La Jolla, CA (US); Timothy KERSSEN, San Diego, CA (US); Xiaoyu LIU, San Diego, CA (US); Francesco CAROBOLANTE, San Diego, CA (US); Yung-Ho TSAI, San Diego, CA (US); Kelsey BURRELL, Santee, CA (US); Andrew ARNETT, San Diego, CA (US); Sumukh SHEVDE, Carlsbad, CA (US); Charles Edward WHEATLEY, Del Mar, CA (US)

(21) Appl. No.: 15/191,378

(22) Filed: Jun. 23, 2016

(51) Int. Cl. H02J 50/12; H02J 7/02; H02J 50/40; H02J 7/04; H02J 50/80

(52) U.S. Cl. CPC H02J 50/12; H02J 7/045; H02J 50/80; H02J 50/40; H02J 7/025

(57) ABSTRACT

A wireless power transmitter system includes: a power delivery structure comprising power transmitting elements (power transmitting elements), each of which is configured to induce a field, and configured to adapt to an exterior shape of an entity that contains a receiver; a power circuit configured to provide power to the power transmitting elements selectively; and a controller configured to: determine an electrical characteristic, other than power transfer to the receiver, associated with actuating at least one of the power transmitting elements; determine at least one power transmitting element subset, based on the electrical characteristic, containing less than all, and at least one, of the power transmitting elements; select, based on power transferred to the receiver, one or more charging power transmitting elements to use to charge the receiver wirelessly; and cause the power circuit to provide power to the one or more charging power transmitting elements.

### TECHNICAL FIELD

The disclosure relates generally to wireless power delivery to electronic devices, and in particular to selective power transmitting element use for wireless power transfer, e.g., to implanted electronic devices.

### BACKGROUND

An increasing number and variety of electronic devices are powered via rechargeable batteries. Such devices include mobile phones, portable music players, laptop computers, tablet computers, computer peripheral devices, communication devices (e.g., BLUETOOTH devices), digital cameras, hearing aids, and the like. While battery technology has improved, battery-powered electronic devices increasingly require and consume greater amounts of power. As such, these devices frequently require recharging. Rechargeable devices are often charged via wired connections that require cables or other similar connectors that are physically connected to a power supply. Cables and similar connectors may sometimes be inconvenient or cumbersome and have other drawbacks. Wireless power charging systems may allow users to charge and/or power electronic devices without physical, electro-mechanical connections, thus simplifying the use of the electronic device.

Further, an increasing number of electronic devices are being implanted in patients. For example, implantable electronic devices include pace makers, cochlear implants, retinal implants, and biometric monitoring systems for monitoring a variety of parameters such as blood characteristics. Wired recharging of these devices is often undesirable.

In wireless energy transfer systems, a power transmitting element sends energy wirelessly to a power receiving element. The efficiency of the energy transfer depends on the alignment of the power transmitting element and power receiving element. If either or both of the power transmitting and receiving elements lie on non-planar surfaces, then alignment of the power transmitting and receiving elements is difficult, particularly if the power transmitting and receiving elements are rigid. Further, it is undesirable to rely on a user to align the power transmitting and receiving elements.

### SUMMARY

An example wireless power transmitter system configured to charge a receiver wirelessly includes: a power delivery structure comprising a plurality of power transmitting elements power transmitting elements each of which is configured to induce a field while actuated, the power delivery structure being configured to adapt to an exterior shape of an entity that contains the receiver; a power circuit communicatively coupled to the power transmitting elements and configured to provide power to the power transmitting elements selectively; and a controller communicatively coupled to the power circuit and configured to: determine an electrical characteristic, other than power transfer to the receiver, associated with actuating at least one power transmitting element power transmitting element of the plurality of power transmitting elements; determine at least one power transmitting element power transmitting element subset based on the electrical characteristic, each of the at least one power transmitting element power transmitting element subset containing less than all, and at least one, of the plurality of power transmitting elements; select, based on power transferred to the receiver from one or more of the at least one power transmitting element power transmitting element subset, one or more charging power transmitting elements from the one or more of the at least one power transmitting element power transmitting element subset to use to charge the receiver wirelessly; and cause the power circuit to provide power to the one or more charging power transmitting elements to charge the receiver wirelessly.

An example method of wirelessly charging a device includes: actuating at least one power transmitting element of a plurality of power transmitting elements of a power delivery structure configured to adapt to an exterior shape of an entity that includes the device, each of the plurality of power transmitting elements being configured to induce a field while actuated; determining an electrical characteristic, other than power transfer to the device, associated with actuating the at least one power transmitting element; determining at least one power transmitting element power transmitting element subset based on the electrical characteristic, each of the at least one power transmitting element power transmitting element subset containing less than all, and at least one, of the plurality of power transmitting elements; selecting, based on power transferred to the device from one or more of the at least one power transmitting element power transmitting element subset, one or more charging power transmitting elements from the one or more of the at least one power transmitting element subset to use to charge the device wirelessly; and charging the device wirelessly using the one or more charging power transmitting elements.

Another example wireless power transmitter system configured to charge a receiver wirelessly includes: means for disposing a plurality of power transmitting elements, each of which is configured to induce a field while actuated, adjacent to and along a non-flat extent of an exterior of an entity that contains the receiver; means for selectively actuating at least one power transmitting element of the plurality of power transmitting elements; means for determining an electrical characteristic, other than power transfer to the device, associated with actuating the at least one power transmitting element; means for determining at least one power transmitting element subset based on the electrical characteristic, each of the at least one power transmitting element subset containing less than all, and at least one, of the plurality of power transmitting elements; and means for selecting, based on power transferred to the device from one or more of the at least one power transmitting element subset, one or more charging power transmitting elements from the one or more of the at least one power transmitting element subset to use to charge the device wirelessly.

Implementations of such a system may include one or more of the following features. The means for determining the electrical characteristic comprise means for determining an impedance for each of the plurality of power transmitting elements, and the means for determining the at least one power transmitting element subset are configured to determine the at least one power transmitting element subset such that every power transmitting element of the at least one power transmitting element subset has an impedance that differs from a reference impedance by greater than a threshold amount. The means for determining the impedance comprise means for detecting, for a respective power transmitting element of the plurality of power transmitting elements, a voltage and a current in the respective power transmitting element while the respective power transmitting element is actuated. The reference impedance is an impedance of the respective power transmitting element without any object adjacent to the means for disposing being close enough to the respective power transmitting element to affect the impedance of the respective power transmitting element significantly. The reference impedance is based on impedances of at least two of the plurality of power transmitting elements. The at least one power transmitting element subset comprises a plurality of candidate power transmitting elements each having an impedance that differs from the reference impedance by greater than the threshold amount, the means for determining the electrical characteristic further comprise means for determining power coupling between one or more combinations of the candidate power transmitting elements, and the means for selecting the one or more charging power transmitting elements comprise means for selecting one or more of the combinations of the candidate power transmitting elements such that every power transmitting element in every selected combination of the candidate power transmitting elements is an actuated power transmitting element, a well-coupled power transmitting element, or both, wherein each well-coupled power transmitting element is a power transmitting element that receives at least a threshold amount of power from one or more actuated power transmitting elements.

Also or alternatively, implementations of such a system may include one or more of the following features. The at least one power transmitting element subset comprises a plurality of candidate power transmitting elements each having an impedance that differs from the reference impedance by greater than the threshold amount, the means for determining the electrical characteristic further comprise means for determining one or more magnetic fields induced by actuating at least one of the candidate power transmitting elements, and the means for selecting the one or more charging power transmitting elements comprise means for selecting power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof. The electrical characteristic comprises power coupling between two or more of the power transmitting elements, and the means for selecting the one or more charging power transmitting elements comprise means for selecting two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements. The electrical characteristic comprises one or more magnetic fields induced by actuating the at least one power transmitting element, and the means for selecting the one or more charging power transmitting elements comprise means for selecting two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof. The one or more charging power transmitting elements are one or more previously-selected charging power transmitting elements, the system further comprising: means for actuating, after beginning to charge the device, a previously-unselected power transmitting element from the at least one power transmitting element subset; and means for continuing to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements. The at least one power transmitting element subset comprises at least two power transmitting element subsets, and wherein the means for selecting the one or more charging power transmitting elements comprises: means for selectively actuating the two or more power transmitting element subsets at least one power transmitting element subset at a time; means for measuring power received by the device in response to selectively actuating the two or more power transmitting element subsets; and means for selecting, as the one or more charging power transmitting elements, the power transmitting element subset of the two or more power transmitting element subsets corresponding to a highest amount of power coupled to the device.

An example non-transitory, processor-readable storage medium storing processor-readable includes instructions configured to cause a processor to: actuate at least one power transmitting element of a plurality of power transmitting elements each of which is configured to induce a field while actuated; determine an electrical characteristic, other than power transfer to the device, associated with actuating the at least one power transmitting element; determine at least one power transmitting element subset based on the electrical characteristic, each of the at least one power transmitting element subset containing less than all, and at least one, of the plurality of power transmitting elements; select, based on power transferred to the device from one or more of the at least one power transmitting element subset, one or more charging power transmitting elements from the one or more of the at least one power transmitting element subset to use to charge the device wirelessly; and charge the device wirelessly using the one or more charging power transmitting elements.

Implementations of such a storage medium may include one or more of the following features. The instructions configured to cause the processor to determine the electrical characteristic are configured to cause the processor to determine an impedance for each of the plurality of power transmitting elements, and the instructions configured to cause the processor to determine the at least one power transmitting element subset are configured to cause the processor to determine the at least one power transmitting element subset such that every power transmitting element of the at least one power transmitting element subset has an impedance that differs from a reference impedance by greater than a threshold amount. The instructions configured to cause the processor to determine the impedance comprise instructions configured to cause the processor to detect, for a respective power transmitting element of the plurality of power transmitting elements, a voltage and a current in the respective power transmitting element while the respective power transmitting element is actuated. The reference impedance is an impedance of the respective power transmitting element without any object adjacent to a structure including the power transmitting element being close enough to the respective power transmitting element to affect the impedance of the respective power transmitting element significantly. The reference impedance is based on impedances of at least two of the plurality of power transmitting elements. The at least one power transmitting element subset comprises a plurality of candidate power transmitting elements each having an impedance that differs from the reference impedance by greater than the threshold amount, the instructions further comprise instructions configured to cause the processor to determine another electrical characteristic by determining power coupling between one or more combinations of the candidate power transmitting elements, and the instructions configured to cause the processor to select the one or more charging power transmitting elements comprise instructions configured to cause the processor to select one or more of the combinations of the candidate power transmitting elements such that every power transmitting element in every selected combination of the candidate power transmitting elements is an actuated power transmitting element, a well-coupled power transmitting element, or both, wherein each well-coupled power transmitting element is a power transmitting element that receives at least a threshold amount of power from one or more actuated power transmitting elements.

Also or alternatively, implementations of such a system may include one or more of the following features. The at least one power transmitting element subset comprises a plurality of candidate power transmitting elements each having an impedance that differs from the reference impedance by greater than the threshold amount, the instructions further comprise instructions configured to cause the processor to determine another electrical characteristic by determining one or more magnetic fields induced by actuating at least one of the candidate power transmitting elements, and the instructions configured to cause the processor to select the one or more charging power transmitting elements comprise instructions configured to cause the processor to select power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof. The electrical characteristic comprises power coupling between two or more of the power transmitting elements, and the instructions configured to cause the processor to select the one or more charging power transmitting elements comprise instructions configured to cause the processor to select two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements. The electrical characteristic comprises one or more magnetic fields induced by actuating the at least one power transmitting element, and the instructions configured to cause the processor to select the one or more charging power transmitting elements comprise instructions configured to cause the processor to select two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof. The one or more charging power transmitting elements are one or more previously-selected charging power transmitting elements, the instructions further comprising instructions configured to cause the processor to: actuate, after beginning to charge the device, a previously-unselected power transmitting element from the at least one power transmitting element subset; and continue to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements. The at least one power transmitting element subset comprises at least two power transmitting element subsets, and wherein the instructions configured to cause the processor to select the one or more charging power transmitting elements comprise instructions configured to cause the processor to: selectively actuate the two or more power transmitting element subsets at least one power transmitting element subset at a time; determine power received by the device in response to selectively actuating the two or more power transmitting element subsets; and select, as the one or more charging power transmitting elements, the power transmitting element subset of the two or more power transmitting element subsets corresponding to a highest amount of power coupled to the device.

The following detailed description and accompanying drawings provide a better understanding of the nature and advantages of the disclosure.

### BRIEF DESCRIPTION OF THE DRAWINGS

Drawing elements that are common among the following figures may be identified using the same reference numerals.

With respect to the discussion to follow and in particular to the drawings, the particulars shown represent examples for purposes of illustrative discussion, and are presented in the cause of providing a description of principles and conceptual aspects of the disclosure. In this regard, no attempt is made to show implementation details beyond what is needed for a fundamental understanding of the disclosure. The discussion to follow, in conjunction with the drawings, makes apparent to those of skill in the art how embodiments in accordance with the disclosure may be practiced.

FIG. 1 is a functional block diagram of an example of a wireless power transfer system.

FIG. 2 is a functional block diagram of an example of another wireless power transfer system.

FIG. 3 is a schematic diagram of an example of a portion of transmit circuitry or receive circuitry of the system shown in FIG. 2.

FIG. 4 is a simplified diagram of a wireless power charging environment.

FIG. 5 is a simplified diagram of a wireless power transmitting system shown in FIG. 4.

FIG. 6 is a cross-sectional view of an entity and the wireless power transmitting system shown in FIG. 4.

FIG. 7 is a cross-sectional view of another entity and another example of a wireless power transmitting system.

FIG. 8 is a block flow diagram of a method of wirelessly charging a device.

FIG. 9 is a side view of a fan with a wireless power transmitting system draped over the fan.

FIG. 10 is a perspective view of a wireless power transmitting system disposed over a display that includes power transmitting elements.

FIGS. 11-12 are simplified diagrams of inductive and capacitive, respectively, power transmitting elements with simple connections to a switch matrix.

FIG. 13 is a simplified diagram of a configurable inductive power transmitting element.

FIG. 14 is a simplified diagram of a configurable capacitive power transmitting element.

FIG. 15 is a simplified diagram of an array of power transmitting repeaters connected to a driving power transmitting element.

FIG. 16 is a simplified block diagram of a wireless power receiving system.

FIGS. 17-18 are perspective views of a wireless power receiving system as part of a flashlight in use and while charging, respectively.

### DETAILED DESCRIPTION

Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

Techniques are discussed herein for wireless power transfer to a receiver. For example, power transmitting elements are included in a power delivery structure that can adapt to an exterior shape of an entity containing the receiver. The power transmitting elements may, for example, be attached to a flexible material. The power transmitting elements may also be flexible, and are configured to wirelessly transfer power to the receiver. The material may be placed adjacent to the entity that includes the receiver.

The power transmitting elements may be selectively driven (i.e., powered, actuated) to transfer power to the receiver. To select which power transmitting elements to drive, a multi-stage process may be performed. For example, in a first stage, power transmitting elements with impedances indicative of the power transmitting elements being capable of charging the receiver (e.g., having impedances differing significantly from a reference impedance (e.g., their respective free-space impedances and/or from an impedance based on the impedances of the power transmitting elements)) may be selected for further processing. In a second stage, the power transmitting elements selected from the first stage (if the first stage was implemented) are tested to see which power transmitting elements couple well with each other. In a third stage, the power transmitting elements selected from the second stage, or from the first stage if the second stage is omitted, are tested to see which power transmitting elements couple power well to the receiver. Preferably, the power transmitting element(s), e.g., one or more combinations of power transmitting elements, that couple the most power, or couple power the most efficiently, to the receiver are selected to be used to charge the receiver. These examples, however, are not exhaustive.

Items and/or techniques described herein may provide one or more of the following capabilities, as well as other capabilities not mentioned. Wireless power transfer efficiency may be increased by placing one or more wireless power transfer elements close to an entity that includes a device to be charged, and selectively driving the power transfer element(s) that is(are) near the entity and that provide the best power transfer available to the device to be charged. Power transfer elements may be selectively driven to attempt to match transmitter and receiver sizes and/or to align the transmitter and receiver. Power transfer elements may be selectively driven to attempt to produce a substantially uniform field to charge a receiver. Wireless charging rate may be increased or even optimized for a relationship between power transmitting element(s) and a receiver. A wide range of receiver sizes and/or shapes may be charged. High power levels may be produced (e.g., using multiple power transmitting element couplings) with a low average field. A device may be wirelessly charged despite being contained in an entity that contains metal. A device may be wirelessly charged despite being contained in an oddly-shaped entity. Good alignment of one or more power transmitting entities and a receiver may be achieved easily, even without requiring a specific orientation of an entity containing a device to be charged and an apparatus that retains the power transmitting entities. A wireless power transmitting system and/or a wireless power receiving system may be easily stored and/or transported. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

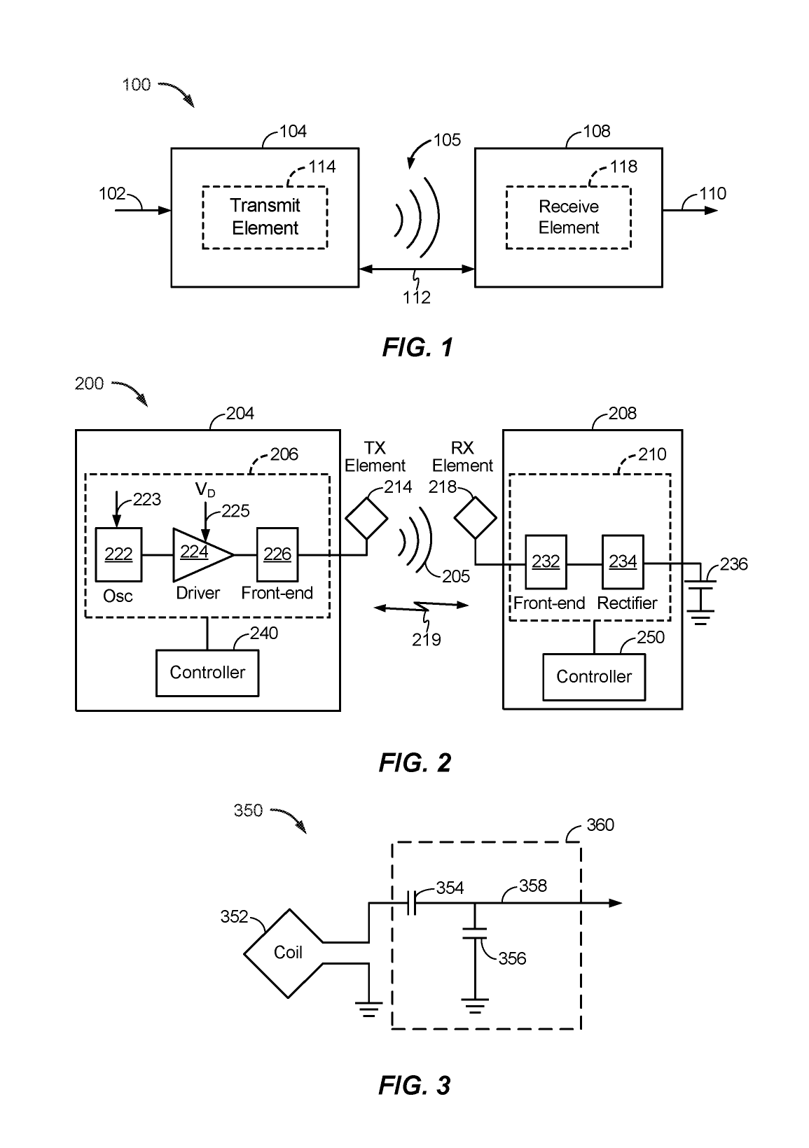

FIG. 1 is a functional block diagram of an example of a wireless power transfer system 100. Input power 102 may be provided to a transmitter 104 from a power source (not shown in this figure) to generate a wireless (e.g., magnetic, electric, or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant coupling techniques allow for improved efficiency and power transfer over various distances and with a variety of power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 2 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power transmitting element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power transmitting element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and may generate an output power for storing or consumption by a battery (or load) 236 coupled to the output or receive circuitry 210.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

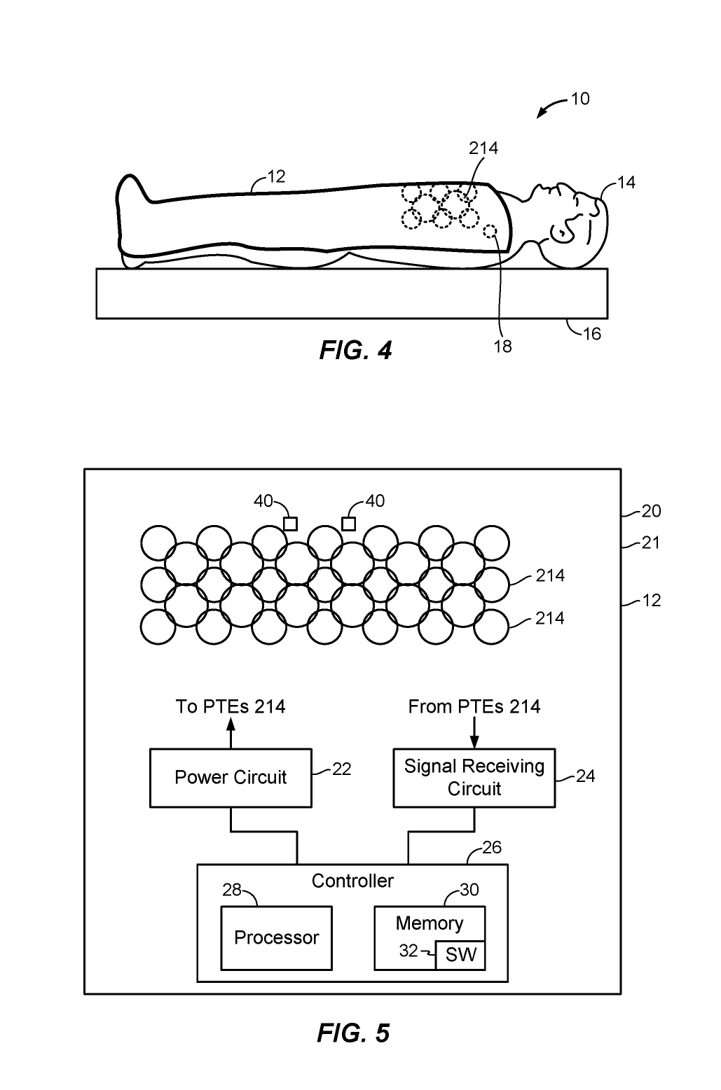

Referring to FIG. 4, with further reference to FIGS. 1-3, an example of a wireless power charging environment 10 includes a wireless power transmitter system 12 disposed over an entity 14, and a support 16. The transmitter 12 is configured to be flexible and to adapt/conform, at least partially, to an exterior shape of the entity 14 containing a receiver 18 to be charged. In the example shown in FIG. 4, the transmitter 12 includes a blanket containing numerous power transmitting elements 214, the entity 14 is a person, the receiver 18 is an implant disposed inside of the person 14, and the support 16 is a bed. Many different types of implants may be used. For example, an implant may facilitate or enable diagnosis and/or treatment of diseases or other conditions. Also or alternatively, an implant may be used for neuromodulation to monitor and/or stimulate a nerve, e.g., in contact with, or in close proximity to, the implant. Also or alternatively, an implant may control (e.g., regulate) and/or monitor a status or chemical value of a person's body (e.g., monitor a brain or nervous system and deliver electrical stimulation or medication, e.g., to relieve pain and/or restore and/or facilitate function). Also or alternatively, an implant may be an insulin monitor, an insulin provider, a hearing aid, a pacemaker, or other device. The environment 10 shown in FIG. 4, however, is an example and numerous other examples of environments may be used. For example, the transmitter 12 may not be a blanket (e.g., may include an article of clothing or other flexible material), the entity 14 may not be a person, but could be a pet or other animal, robot, or any other machine or organism containing a device requiring wireless energy transfer (and even if the entity 14 is a person, the support 16 may not be a bed), the receiver 18 may not be disposed inside of the entity 14 (e.g., may be disposed on the entity 14), etc.

Referring also to FIG. 5, an example of the system 12 includes a power delivery structure 20, a power circuit 22, a signal receiving circuit 24, and a controller 26. The power delivery structure 20 includes the power transmitting elements 214 and, in the example shown in FIG. 5, the power circuit 22, the signal receiving circuit 24, and the controller 26. The system 12 is configured to adapt to various examples of the entity 14 to provide power wirelessly to the receiver 18 associated with (e.g., contained in or attached to) the entity 14. The system 12 is configured to determine one or more of the power transmitting elements 214 to use to charge (provide power to) the receiver 18 wirelessly, e.g., to charge the receiver 18 efficiently. For example, the controller 26, as discussed further below, may determine which of the power transmitting elements 214 will provide sufficient power (and possibly optimum possible power given the configuration and present disposition of the power delivery structure 20) to the receiver 18 and may actuate only those power transmitting elements 214. To this end, the power circuit 22 is communicatively coupled to the power transmitting elements 214 and configured to deliver power selectively to the power transmitting elements 214. For example, the power circuit 22 may be configured similarly to the transmit circuit 206 shown in FIG. 2, and configured to selectively provide power to each of the power transmitting elements 214. The signal receiving circuit 24 is communicatively coupled to the power transmitting elements 214 and configured to receive, process, and provide to the controller 26 communication signals received by the power transmitting elements 214 from the receiver 18.

The power delivery structure 20 is configured to retain the power transmitting elements 214 and to permit positioning of the power transmitting elements 214 close to the entity 14. The power delivery structure 20 includes a retention structure 21 that retains the power transmitting elements 214. The power transmitting elements 214 may be retained by the retention structure 21 in a variety of manners. For example, the power transmitting elements 214 may be attached to the retention structure 21 using an adhesive. Also or alternatively, the power transmitting elements 214 may be contained within layers and/or pockets of the retention structure 21. Also or alternatively, the power transmitting elements 214 may be affixed to the retention structure 21 using mechanical apparatus such as stitches. Also or alternatively, the power transmitting elements 214 may be adhered to a substrate (e.g., paper) that is retained by the retention structure 21. Still other retention techniques may be used. The retention structure 21 may be configured in a variety of shapes and/or sizes, such as rectangular, circular, irregularly shaped, etc. The retention structure 21 may be a flexible material, e.g., one or more layers or sheets of flexible material such as fabric, plastic, etc. The retention structure may be discontinuous, e.g., comprising connections between adjacent power transmitting elements 214 without a continuous material connected to all the power transmitting elements 214.

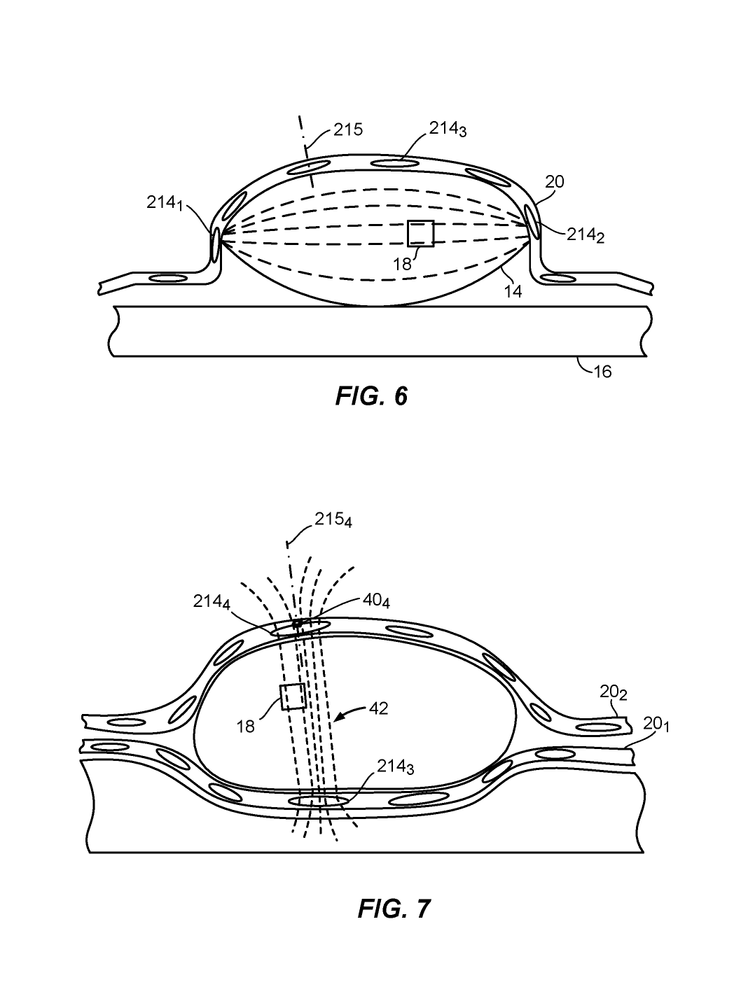

The power delivery structure 20 is configured to permit positioning of the power transmitting elements 214 close to the entity 14. The power delivery structure 20 is configured to adapt to at least a portion of an exterior of the entity 14, with the entity 14 containing the receiver 18, and/or being attached to the receiver 18. For example, referring also to FIGS. 6-7, the power delivery structure 20 can conform to the exterior of the entity 14, here a torso of a person shown in FIG. 4. The retention structure 21 is sufficiently flexible that it may conform to at least part of an outer surface of the entity 14 to facilitate the power transmitting elements 214 coming in close contact with the entity 14 to facilitate power transfer from the power transmitting elements 214 to the receiver 18. Preferably, the retention structure 21 is sufficiently pliable to conform to significant portions of the entity 14, for example a torso or appendage of a person, a housing of a mobile phone, a body of an appliance (e.g., a toaster, a fan, etc.), etc. The retention structure 21 may be disposed against the entity 14 such that the power transmitting elements 214 adjacent to the entity 14 have axes 215 approximately perpendicular to the surface of the entity 14 at the locations of the power transmitting elements 214, respectively. As shown in FIG. 7, the system 12 may comprise multiple, separate power delivery structures 20₁, 20₂, although a single power delivery structure could be disposed similarly to the two power delivery structures 20 shown in FIG. 7, e.g., by folding and wrapping the power delivery structure around the entity 14.

The power transmitting elements 214 may be configured and disposed with respect to the retention structure 21 to facilitate power transfer to the receiver 18. As shown in FIG. 5, as one example, the power transmitting elements 214 may be arranged in a uniform pattern of rows, may have different sizes but similar shapes, and may overlap with neighboring power transmitting elements 214. This, however, is but one example. In other configurations, all the power transmitting elements may have the same size and shape, or may have different sizes and/or shapes. These sizes and/or shapes of the power transmitting elements may facilitate conformance of the power delivery structure 20 to the entity 14, e.g., with smaller power transmitting elements 214 allowing greater contortion of the retention structure 21. The power transmitting elements 214 may be non-uniformly arranged, e.g., being irregularly arranged such as randomly disposed in the power delivery structure 20. Further still, the power transmitting elements 214 may be disposed throughout the power delivery structure 20 or, as in the example shown in FIG. 5, the power transmitting elements 214 are disposed over a small portion of the overall area of the power delivery structure 20. The power transmitting elements 214 may be disposed in different areas of the power delivery structure 20, with concentrations of the power transmitting elements 214 in one or more of those areas. For example, a cluster of the power transmitting elements 214 may be provided in each area expected to have a receiver 18 for receiving wireless power. For example, if a person has a heart pacemaker and also an implant in the person's leg, then a customized system 12 may be provided where none of the power transmitting elements 214 are clustered in a region of the power delivery structure 20 that will be disposed in proximity to the person's chest, and further ones of the power transmitting elements 214 are clustered in a region of the power delivery structure 20 that will be disposed in proximity to the person's leg containing the implant. The power transmitting elements 214 may be configured to be flexible to facilitate the contortion of the power delivery structure 20. For example, the power transmitting elements 214 may be thin metallic coils that may be flexed.

The power transmitting elements 214 may provide one or more types of wireless power transfer to the receiver 18. For example, the power transmitting elements 214 may provide inductive and/or capacitive power coupling. The power transmitting elements 214 may be configured as coils that induce magnetic fields when actuated, or as plates that induce electric fields when actuated. More than one type of the power transmitting elements 214 may be provided in the system 12.

The power circuit 22 and/or the signal receiving circuit 24 is (are) configured to provide information to the controller 26 regarding signals at the power transmitting elements 214. For example, the power circuit 22 and/or the signal receiving circuit 24 may provide information regarding the voltage and/or current at any one of the power transmitting elements 214. Also or alternatively, if the power circuit 22 includes a matching circuit configured to adjust an impedance associated with any one of the power transmitting elements 214 to attempt to maximize power transmitted from the power transmitting element 214, then the power circuit 22 may provide information regarding the impedance adjustment (e.g., capacitance, resistance, and/or inductance) associated with the PGE 214, e.g., that yielded the best power transmission from the power transmitting element 214 and thus presumably the best power coupling to the receiver 18. The signal receiving circuit 24 is configured to provide indications of communications received from the receiver 18. For example, these communications may indicate amounts of power received by the receiver 18.

Optionally, the system 12 may include three-dimensional field sensors 40 as shown in FIG. 5. For example, the sensors 40 may be configured to sense and/or determine three-dimensional magnetic fields. To sense three-dimensional magnetic fields, the sensors 40 may be semiconductor devices that use the Hall effect to detect the magnetic field. Alternatively, the sensors 40 may each comprise three orthogonal loops configured to sense magnetic flux. The sensors 40 may be configured to compute and report an intensity and/or a direction of the three-dimensional magnetic field to the controller 26, and/or to provide raw measurement data from which the controller 26 can determine the three-dimensional magnetic field direction and/or intensity. While only two of the sensors 40 are shown in FIG. 5, preferably there would be numerous sensors 40 disposed throughout the power delivery structure 20 interspersed with the power transmitting elements 214. Increasing the quantity, and strategically selecting locations, of the sensors 40 may improve granularity of three-dimensional magnetic field directions and locations that may be determined across the power delivery structure 20, and thus the accuracy of the determined direction of the magnetic field associated with any particular one of the power transmitting elements 214. One or more of the sensors 40 may be disposed within perimeters of the power transmitting elements 214 in addition to or instead of adjacent to the power transmitting elements 214 as shown in FIG. 5.

While FIG. 5 shows the power circuit 22, the signal receiving circuit 24, and the controller 26 disposed in the power delivery structure 20, one or more of the power circuit 22, the signal receiving circuit 24, or the controller 26 may be disposed outside of or displaced from the power delivery structure 20. For example, one or more connectors may be provided, attached to the power delivery structure 20, that is(are) configured to connect to the power circuit 22, the signal receiving circuit 24, and/or the controller 26. Further, multiple, separate power delivery structures 20 may be provided and the controller 26 may be configured to actuate (drive) the power transmitting elements 214 associated with the separate power delivery structures 20, e.g., using the power circuit 22 and the signal receiving circuit 24 separate from the power delivery structures 20 or using circuits 22, 24 associated with the power delivery structures 20.

The controller 26 comprises a computer system that includes a processor 28 and a memory 30 including software (SW) 32. The processor 28 is preferably an intelligent hardware device, for example a central processing unit (CPU) such as those made or designed by QUALCOMM®, ARM®, Intel® Corporation, or AMD®, a microcontroller, an application specific integrated circuit (ASIC), etc. The processor 28 may comprise multiple separate physical entities that can be distributed in the controller 26. The memory 30 may include random access memory (RAM) and/or read-only memory (ROM). The memory 30 is a non-transitory, processor-readable storage medium that stores the software 32 which is processor-readable, processor-executable software code containing instructions that are configured to, when performed, cause the processor 28 to perform various functions described herein. The description may refer only to the controller 26 or only the processor 28 performing the functions, but this includes other implementations such as where the processor 28 executes software and/or firmware. The software 32 may not be directly executable by the processor 28 and instead may be configured to, for example when compiled and executed, cause the processor 28 to perform the functions. Whether needing compiling or not, the software 32 contains the instructions to cause the processor 28 to perform the functions. The processor 28 is communicatively coupled to the memory 30. The processor 28 in combination with the memory 30 provide means for performing functions as described herein. The software 32 can be loaded onto the memory 30 by being downloaded via a network connection, uploaded from a disk, etc.

The controller 26 is configured to determine which of the power transmitting elements 214 to actuate to charge the receiver 18. The controller 26 is configured, in particular, to determine which of the power transmitting elements 214 to test for sufficient charging of the receiver 18, and further to determine which of the power transmitting elements 214 that were tested to use in order to charge the receiver 18. These operations may, and likely will, result in the power transmitting elements 214 being tested for sufficient charging of the receiver 18 being a downsampled set (reduced number) of all of the power transmitting elements 214, and may, and likely will, result in fewer than all the power transmitting elements 214 that were tested being used to charge the receiver 18. The controller 26 may perform multiple rounds or stages of analysis of the power transmitting elements 214, each of which may result in downsampled/reduced numbers of power transmitting elements 214 being further analyzed, to determine which of the power transmitting elements 214 to actuate to determine whether sufficient power (e.g., above a threshold amount of power such as a threshold percentage of battery capacity per time or a threshold current per time, etc.) is being provided to the receiver 18. The controller 26 may be configured to determine an electrical characteristic, other than power transfer to the receiver 18, associated with actuating at least one of the power transmitting elements 214. The controller 26 may also determine the power transfer to the receiver 18, and this may be used to help determine the power transmitting element(s) power transmitting element(s) 214 for further analysis or for charging the receiver 18, but at least one other electrical characteristic is used by the controller 26 to determine the power transmitting element(s) 214 for further analysis as to whether the power transmitting element(s) 214 should be used to charge the receiver 18. Thus, the controller 26 may be configured to determine at least one power transmitting element subset based on the electrical characteristic, where each of the at least one power transmitting element subset contains less than all, and at least one, of the power transmitting elements 214. The controller 26 may further be configured to select, based on power transferred to the receiver 18 from one or more of the at least one power transmitting element subset, one or more charging power transmitting elements, from the one or more of the at least one power transmitting element subset, to use to charge the receiver 18 wirelessly. The controller 26 may further be configured to cause the power circuit 22 to provide power to the one or more charging power transmitting elements to charge the receiver 18 wirelessly. Thus, for example, the controller 26 may determine several subsets of the power transmitting elements 214, each subset containing one or more of the power transmitting elements 214, select the subset(s) of the power transmitting elements 214 to charge the receiver 18 based on amounts of power delivered to the receiver 18 by the various subsets of the power transmitting elements 214, and actuate the selected subset(s) of the power transmitting elements 214.

The controller 26 is preferably configured to perform impedance filtering of the power transmitting elements 214, to perform coupling filtering of the impedance-filtered power transmitting elements, and to perform power transfer filtering of the impedance-filtered power transmitting elements and/or the coupling-filtered power transmitting elements 214 to determine the charging power transmitting elements. The controller 26 is preferably configured to determine impedance (as the electrical characteristic) for each of the power transmitting elements 214 and to choose for further consideration the power transmitting elements 214 with impedances indicative of the corresponding power transmitting elements 214 possibly being disposed near enough to the receiver 18 to provide significant power to the receiver 18. The power transmitting element(s) 214 that pass the impedance filtering comprise at least one power transmitting element subset of one or more candidate power transmitting elements. The controller 26 may also, or alternatively, be configured to determine combinations of the power transmitting elements 214 that couple well with each other, or are at least likely to couple well with each other, as charging power transmitting elements such that each charging power transmitting element is an actuated power transmitting element, a well-coupled (or likely well-coupled) power transmitting element, or both. To do this (these) the controller 26 may determine power coupling or magnetic field intensity and/or relative direction being the electric characteristic, or being another electrical characteristic (e.g., in addition to impedance). The controller 26 is preferably configured to determine the good-coupling combinations of the power transmitting elements 214 using only the power transmitting elements 214 whose impedances are indicative of the corresponding power transmitting elements 214 possibly being disposed near enough to the receiver 18 to provide significant power to the receiver 18, i.e., only the candidate power transmitting elements 214. The controller 26 is preferably configured to test those power transmitting elements 214 that couple well with each other or are likely to couple well with each other for how much power they transfer to the receiver 18. Thus, the controller 26 may be configured to filter the number of power transmitting elements 214 for further consideration based on impedances of the power transmitting elements 214, to further filter these power transmitting elements 214 based on coupling between the power transmitting elements 214, and to determine which of these power transmitting elements 214 provide sufficient power to the receiver 18 and should be used as charging power transmitting elements. Alternatively, the controller 26 may be configured to omit the impedance filtering or the power transmitting element coupling filtering. Further, even if the controller 26 implements the impedance filtering and the power transmitting element coupling filtering, the controller 26 may test one or more of the power transmitting elements 214 that passed the impedance filtering but not the coupling filtering for power transfer to the receiver 18. The controller 26 may determine to use one or more of these power transmitting elements 214 as one or more charging power transmitting elements as appropriate, e.g., if the power transmitting element(s) 214 transfers (transfer) sufficient power to the receiver 18 and/or sufficiently increase power transfer efficiency, etc. The individual power transmitting element(s) 214 so determined to be used for charging the receiver 18 may be used to charge the receiver 18 in addition to any combination of power transmitting elements 214 determined to be used for charging the receiver 18.

Filtering Power Transmitting Elements Based On Power Transmitting Element Impedance (Impedance Filtering)

If the controller 26 is configured to use power transmitting element impedance as an indication of likely ability to provide significant power to the receiver 18 as a litmus test for further evaluating the power transmitting elements, the controller 26 may be configured to determine the impedance of each of the power transmitting elements 214 in one or more of a variety of manners. The controller 26 may be configured to receive indications of alternating-current power measurements (i.e., of voltage and current), corresponding to an actuated one of the power transmitting elements 214, from the power circuit 22 and/or the signal receiving circuit 24. The power transmitting element 214 may be actuated as though the power transmitting element 214 was being used to charge a device, or may be actuated with less power, e.g., with a lower current, than if the power transmitting element 214 was being used to charge a device, or may have an open-circuit voltage applied to the power transmitting element such that no current flows and no power is transferred. Also or alternatively, the controller 26 may be configured to determine one or more impedance adjustments (real, capacitive, and/or inductive) used to match impedance, e.g., by a matching circuit of the power circuit 22, of each of the power transmitting elements 14 to its environment. Also or alternatively, the controller 26 may be configured to analyze signal reflections to determine impedances of the power transmitting elements 214.

The controller 26 is configured to store and/or determine a reference impedance to compare to the impedance of each of the power transmitting elements 214. The controller 26 may store/determine a single reference impedance to compare to the impedance of every one of the power transmitting elements 214. The controller 26 may be configured to store and/or determine the reference impedance as a free-space impedance of the power transmitting element 214. The free-space impedance of each power transmitting element 214 is the impedance of the corresponding power transmitting element 214 without any object external to the system 12 being adjacent to the power transmitting element 214 (e.g., close enough to the power transmitting element 14 to change a real portion of the impedance significantly, e.g., by a factor of two or more relative to the impedance without any object within a threshold distance (e.g., 1 m or other distance) of the power delivery structure 20 in an area of the power delivery structure 20 corresponding to the power transmitting element 214). Also or alternatively, the controller 26 may be configured to determine the reference impedance based on impedances of at least two of the power transmitting elements 214. For example, the controller 26 may be configured to determine the impedances of all of the power transmitting elements 214, or all of the power transmitting elements 214 whose impedances differ significantly from their free-space impedances, or all of the power transmitting elements 214 whose impedances differ significantly (e.g., by a factor of 2 or more) from their free-space impedances, and to set the reference impedance based on the determined impedances. For example, the controller 26 may be configured to set the reference impedance as an average of the determined impedances, as an average of a majority of the impedances of the power transmitting elements 214, to a level between the impedances of a majority of the power transmitting elements 214 and the impedances of the remaining power transmitting elements 214, or otherwise. For example, if the power delivery structure 20 is placed on a bed, then many if not all of the impedances of the power transmitting elements 214 may be slightly different than their free-space impedances. If a person were to lie on the power delivery structure 20, then a majority of the power transmitting elements 214 may still have the slightly different impedance, while some of the power transmitting elements 214 will have significantly different impedances. As an example, the slightly different impedances may have a real component that is less than a factor of two times different than the real component of the free-space impedances while the significantly-different impedances may have a real component that is a factor of five times or more that of the real component of the free-space impedances. The controller 26 in such a situation may set the reference impedance at two times, or three times, or five times, the real component of the free-space impedance. The reference impedance may be an absolute value, such as a real component of the free-space impedance, or a relative value, such as a value of a ratio of the present impedance and the free-space impedance (or component thereof such as the real component). Alternatively, the reference impedance may be based on a natural system impedance. The natural system impedance is the impedance with the power delivery structure disposed for use (e.g., placed on the entity 14) and the receive element 218 of the receiver 18 open circuited (e.g., per an out-of-band communication). The reference impedance may be set relative to the natural system impedance, e.g., 1.1 times the natural system impedance, or 1.2 times, etc. The reference impedance may be set for each individual power transmitting element 214, e.g., relative to the free-space impedance or the natural system impedance for that power transmitting element 214.

The controller 26 is configured to compare the impedance of each of the power transmitting elements 214 to the reference impedance to determine which power transmitting element(s) 214 is(are) likely to be able to couple significant power to the receiver 18 and thus worthy of further consideration as a possible charging power transmitting element. The controller 26 may be configured to identify each of the power transmitting elements 214 that has an impedance that is significantly different from the reference impedance, e.g., that differs by more than a threshold amount, as a candidate for either a charging power transmitting element or a candidate for further consideration and analysis to determine whether the power transmitting element 214 may or should be used as a charging power transmitting element. For example, the power transmitting elements 214 with significantly different impedances from the reference impedance may further be and analyzed for coupling between each other as discussed below. Also or alternatively, the controller 26 may be configured to selectively actuate the power transmitting elements 214 with significantly different impedances from the reference impedance and monitor the power provided to the receiver 18 as discussed below. The power transmitting element(s) 214 that pass this impedance filtering, and that is (are) thus worthy of further consideration, may be considered as a subset of all the power transmitting elements 214. Alternatively, multiple such power transmitting elements 214 may be considered to be multiple subsets, with any particular power transmitting element subset having as few as one of the power transmitting elements 214 that pass the impedance filtering.

Filtering Power Transmitting Elements Based on Power Transmitting Element Coupling (Coupling Filtering)

The controller 26 may be configured to determine actual coupling, and/or likely coupling, between one or more combinations of the power transmitting elements 214. For example, if a combination of the power transmitting elements 214 provides a magnetic field that is substantially perpendicular to, and substantially uniform across, the power transmitting elements 214 in the combination, then the controller 26 may identify the combination of the power transmitting elements 214 for actuation as a combination for determining whether to use the power transmitting elements 214 to charge the receiver 18.

The controller 26 may be configured to determine actual coupling between combinations of the power transmitting elements 214 by actuating (i.e., causing the power circuit 22 to provide power to) one or more of the power transmitting elements 214 selectively and monitoring power received by other, non-actuated, ones of the power transmitting elements 214. In this case, the controller 26 uses the power transmitting elements 214 as sensors in addition to being used as transmitters. In this configuration, the controller 26 actuates one or more of the power transmitting elements 214 and monitors power received by the other power transmitting elements 214 via the signal receiving circuit 24. Any of the other power transmitting elements 214 that receives more than a threshold amount of power is considered a well-coupled power transmitting element and may be designated by the controller 26 to be part of a coupling combination, or subset, with the actuated power transmitting element(s) 214. The controller 26 may be further configured to actuate the power transmitting element(s) 214 that received more than a threshold amount of power and monitor the power received by the non-actuated power transmitting elements 214 to identify any further power transmitting element(s) 214 that receives (receive) more than the threshold amount of power. To actuate multiple ones of the power transmitting elements 214 as a combination, the controller 26 preferably drives the power transmitting elements 214 with the same drive signal. This will produce an in-phase magnetic or electric field which will produce a stronger field than by driving a single one of the power transmitting elements 214 or by driving the multiple power transmitting elements 214 with different, out-of-phase, drive signals. For example, referring to FIG. 6, with the power transmitting element 214₁ actuated, the power transmitting element 214₂ may receive sufficient power for the power transmitting element 214₂ to be considered to be a well-coupled with the power transmitting element 214₁. The power transmitting elements 214 shown in FIG. 6, with further reference to FIGS. 4-5, are configured to provide power wirelessly to the receiver 18 as driven by the power circuit 22 under the control of the controller 26.

The controller 26 may be configured to determine likely coupling between combinations of the power transmitting elements 214 by actuating one or more of the power transmitting elements 214 selectively to induce a magnetic field, and monitoring the magnetic field associated with other ones of the power transmitting elements 214. In this case, the controller 26 actuates one or more of the power transmitting elements 214 and monitors the induced magnetic field associated with the other power transmitting elements 214 as sensed by the sensors 40 and indicated by the sensors 40 to the controller 26 via the signal receiving circuit 24. Any of the other power transmitting elements 214 that has an associated magnetic field that has an intensity that is greater than a threshold amount, or that has a directionality relative to an axis of the power transmitting element 214 that is within a directionality threshold (e.g., within 10° of parallel to the axis, e.g., perpendicular to a plane of a coil), or a combination thereof, is considered a likely well-coupled power transmitting element, i.e., a power transmitting element that is likely to be well coupled to the actuated power transmitting element(s) 214. For example, referring to FIG. 7, with the power transmitting element 214₃ actuated, the sensor 40₄ associated with the power transmitting element 214₄ may indicate a magnetic field 42 of sufficiently-high intensity and a direction sufficiently parallel to an axis 215₄ of the power transmitting element 214₄ for the power transmitting element 214₄ to be considered to be likely well coupled with the power transmitting element 214₃ (i.e., it is likely that the power transmitting element 214₄ is a well-coupled power transmitting element relative to the power transmitting element 214₃). As shown, the magnetic field 42 is nearly a uniform field. The controller 26 may designate any likely well-coupled power transmitting element(s) 214 to be part of a coupling combination, or subset, with the actuated power transmitting element(s) 214. The controller 26 may be further configured to actuate likely well-coupled power transmitting element(s) 214 and monitor the induced magnetic field associated with the non-actuated power transmitting elements 214 to determine if one or more power transmitting elements 214 should be added to the combination. To actuate multiple ones of the power transmitting elements 214 as a combination, the controller 26 preferably drives the power transmitting elements 214 with the same drive signal.

Selecting Charging Power Transmitting Elements (Power Transfer Filtering)

The controller 26 is configured to determine which of the power transmitting elements 214 to use as charging power transmitting elements for charging the receiver 18. The controller 26 can determine the charging power transmitting elements in one or more of a variety of manners. For example, the controller 26 may be configured to determine power coupled to the receiver 18 by selectively actuating each of the power transmitting elements 214. Also or alternatively, the controller 26 may be configured to implement the impedance filtering and/or the power transmitting element coupling filtering discussed above before attempting to determine power coupled to the receiver 18 by selectively actuating the power transmitting elements 214 that passed the impedance filtering and/or the power transmitting element coupling filtering. Still other techniques may be employed by the controller 26 to determine the charging power transmitting elements.

To determine the charging power transmitting elements 214 without implementing, at least initially, the impedance filtering or the power transmitting element coupling filtering discussed above, the controller 26 may selectively actuate every one of the power transmitting elements 214 and monitor power delivered by the actuated power transmitting element 214 to the receiver 18. The controller 26 may receive indications of power received by the receiver 18 in communications from the receiver 18 received by one or more of the power transmitting elements 214 and relayed to the controller 26 via the signal receiving circuit 24. Any power transmitting element 214 that delivers more than a threshold amount of power to the receiver 18 may be designated as a charging power transmitting element. Further, any power transmitting elements 214 that are determined to couple well to the actuated power transmitting element 214 during this process may also be actuated and used as a charging power transmitting element. Further still, the controller 26 may actuate power transmitting elements 214 that are neighbors of any such charging power transmitting elements. The controller 26 may determine which power transmitting elements 214 are neighbors of the actuated power transmitting elements 214 by using knowledge of a layout of the power transmitting elements 214 in the power delivery structure 20, if known. Also or alternatively, the controller 26 may be configured to determine neighbor power transmitting elements 214 by analyzing the power coupled to the power transmitting elements 214 from the actuated power transmitting elements 214. As radiated power decreases as the inverse of distance squared, the controller 26 can determine neighbor power transmitting elements 214 as the power transmitting elements 214 with the highest amounts of coupled power received, or received power above a neighbor threshold. This technique is essentially the power transmitting element coupling filtering discussed above in the context of also monitoring the power received by the receiver 18. Also or alternatively, there may be multiple power transmitting element subsets each containing at least one of the power transmitting elements 214 and the controller 26 may be configured to selectively actuate two or more power transmitting element subsets at least one power transmitting element subset at a time, and to select as the charging power transmitting element(s) 214 the power transmitting element subset or combination of power transmitting element subsets that corresponds to a highest amount of power coupled to the receiver 18.

The controller 26 may, however, be configured to implement the impedance filtering and/or the power transmitting element coupling filtering discussed above. The controller 26 would implement the filtering technique(s) which would likely result in a reduced quantity of the power transmitting elements 214 to actuate while monitoring for power coupled to the receiver 18. If the controller 26 implements the impedance filtering, then the controller 26 preferably only actuates the power transmitting elements 214 that passed the impedance filtering when determining the power transmitting element coupling. If the controller 26 implements the power transmitting element coupling filtering, then the controller 26 may only actuate the combination(s) of the power transmitting elements 214 that passed the power transmitting element coupling filtering while monitoring the power coupled to the receiver 18. Alternatively, the controller 26 may selectively actuate all of the power transmitting elements 214 identified by the impedance filtering, but when a power transmitting element 214 that is to be actuated is part of a combination identified by the power transmitting element coupling filtering, then preferably all of the power transmitting elements in the combination will be actuated by the controller 26, at least initially. The controller 26 is preferably configured to select the subset(s) of the power transmitting elements 214 that result in more than a threshold amount of power being coupled to the receiver 18. The controller 26 may be configured to actuate all of the subsets of the power transmitting elements 214 (singularly and/or in groups) that passed the impedance filtering and/or the power transmitting element coupling filtering even if a subset or combination of subsets of the power transmitting elements 214 is found that delivers the threshold amount of power to the receiver 18 without actuating all of the power transmitting element subsets simultaneously. Once the threshold amount of power coupled to the receiver 18 is met, the controller 26 may designate further ones of the power transmitting elements 214 as charging power transmitting elements based on the efficiency of power coupled to the receiver 18 by the further ones of the power transmitting elements 214. For example, if a newly-actuated power transmitting element subset increases the power coupled to the receiver 18 by more than a threshold percentage of the power provided to the newly actuated power transmitting element subset, then the controller 26 may designate every power transmitting element 214 in the newly-actuated power transmitting element subset as a charging power transmitting element.

The controller 26 may further be configured to change which of the power transmitting elements 214 are used as charging power transmitting elements. The controller 26 may make an adjustment to the selected set of charging power transmitting elements, e.g., by actuating one or more of the power transmitting elements 214, preferably near the edge(s) of the existing set of charging power transmitting elements. Thus, the controller 26 may add one or more power transmitting elements 214, e.g., that neighbor the existing charging power transmitting element set, and/or cease to actuate one or more power transmitting elements 214, e.g., near the edge(s) of the existing charging power transmitting element set, and analyze the power coupled to the receiver 18 before and after the adjustment. Thus, the controller 26 may actuate a previously-unselected (previously-unactuated) power transmitting element, i.e., a power transmitting element not being used as a charging power transmitting element. The previously-unselected power transmitting element may or may not be limited to being a power transmitting element that passed the impedance filtering and/or the coupling filtering. For example, the controller 26 may determine whether to replace the prior power transmitting element charging set with the new power transmitting element charging set if the new power transmitting element charging set couples at least the threshold amount of power to the receiver 18 and the efficiency of the power coupled to the receiver 18 is higher than with the prior power transmitting element charging set. As other examples, the controller 26 may determine to replace the prior power transmitting element charging set with the new power transmitting element charging set if the new power transmitting element charging set increases the power coupled to the receiver 18 at all, or more than a threshold amount for a marginal (incremental) power coupling increase.

Further, the phase of a signal used to drive a newly-added power transmitting element 214 may be varied and the effect on power coupling to the receiver 18 monitored. For example, in response to a new power transmitting element 214 being actuated (for whatever reason) in addition to at least one other power transmitting element 214 that is already actuated, the controller 26 may vary the phase of the signal driving the power transmitting element 214 over a full 360° and monitor the power delivered to the receiver 18. The controller 26 may choose to actuate the new power transmitting element 214 with the phase that yields the highest power transfer to the receiver 18. Of course, the phase of the driving signal for power transmitting elements 214 other than a new power transmitting element 214 may be varied, the effects on power delivered to the receiver 18 monitored, and phases of the driving signals to the various power transmitting elements 214 selected, e.g., to deliver the highest amount of power to the receiver 18 that was seen while monitoring the phase effects on the power delivered.

Operation

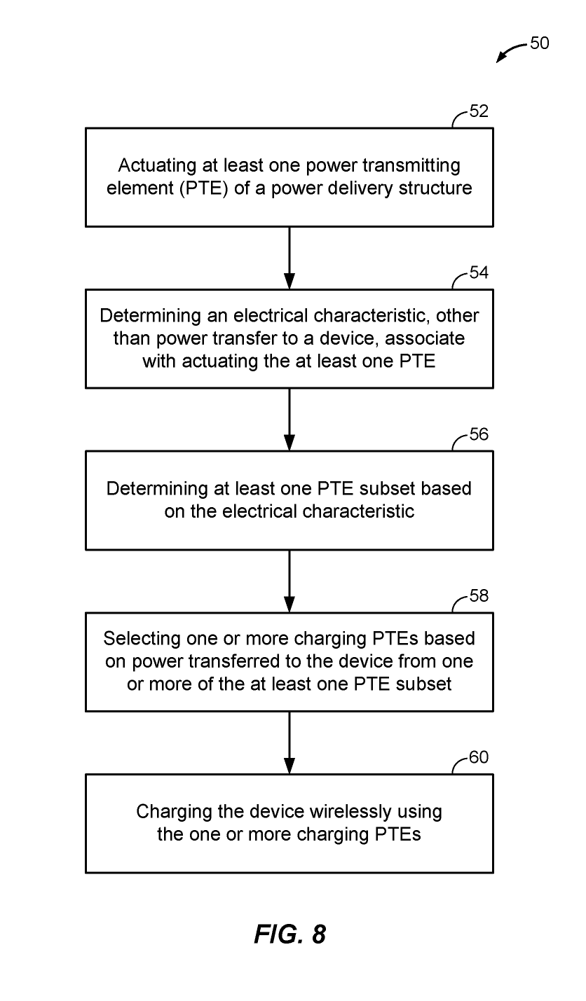

Referring to FIG. 8, with further reference to FIGS. 1-7, a process 50 of wirelessly charging a device includes the stages shown. The process 50 is, however, an example only and not limiting. The process 50 may be altered, e.g., by having stages added, removed, rearranged, combined, performed concurrently, and/or having single stages split into multiple stages.

At stage 52, the process 50 includes actuating at least one power transmitting element of a power delivery structure. For example, this may comprise actuating at least one of the power transmitting elements 214 of the power delivery structure 20 that is configured to adapt to an exterior shape of an entity that includes a device to be charged. The power delivery structure 20 need not be configured to adapt to the entire exterior shape of the entity. For example, the power delivery structure 20 may not be as big as the entire exterior of the entity, and/or may not adapt to small and or extreme shapes (e.g., sharp points and/or edges, and/or narrow slots, etc.). Each of the power transmitting elements is configured to induce a field while actuated. Preferably at this stage, each of the available power transmitting elements are actuated, possibly one at a time and/or in groups, e.g., for the impedance filtering and/or the coupling filtering discussed above.

At stage 54, the process 50 includes determining an electrical characteristic, other than power transfer to a device, associated with actuating at least one power transmitting element. For example, the controller 26 may determine the impedance of each of the actuated power transmitting elements 214 using any of the techniques discussed above, e.g., determining the voltage and current in a respective power transmitting element when the respective power transmitting element is actuated, or other appropriate technique(s). As another example, the controller 26 may determine likely coupling between two or more of the power transmitting elements 214 as the electrical characteristic. In any case, the electrical characteristic is a characteristic other than (although possibly in addition to) power transfer to the device, such as power transfer to the receiver 18.

At stage 56, the process 50 includes determining at least one power transmitting element subset based on the electrical characteristic. Each of the at least one power transmitting element subset contains less than all, but at least one, of the power transmitting elements 214. As an example of the stage 56, the controller 26 may determine one or more power transmitting element subsets such that every power transmitting element in a power transmitting element subset has an impedance that differs from a reference impedance by greater than a threshold amount. The reference impedance may be, for example, a free-space impedance of the respective power transmitting element. As another example, the reference impedance may be based on impedances of at least two of the power transmitting elements 214. For example, as discussed above, the reference impedance maybe an average of impedances of at least some of the power transmitting elements 214. Or, the reference impedance may be based on an impedance measured when the power delivery structure 20 is placed on the subject while the receive element 218 is open-circuited. As another example of the stage 56, the controller may determine one or more power transmitting element subsets such that one or more of the subsets includes a combination of power transmitting elements that couple well with each other or are likely to couple well with each other.

At stage 58, the process 50 includes selecting one or more charging power transmitting elements based on power transferred to the device from one or more of the at least one power transmitting element subset. For example, the controller 26 determines the charging power transmitting elements from the power transmitting elements that have passed in the impedance filtering and/or the coupling filtering discussed above. Thus, for example, if the electrical characteristic is impedance such that the at least one power transmitting element subset comprises power transmitting elements each having an impedance that differs from the reference impedance by greater than a threshold amount, then the process 50 may further include determining another electrical characteristic by determining power coupling or likely power coupling between one or more combinations of the power transmitting elements 214 that passed the impedance filtering. Alternatively, the electrical characteristic is power coupling or likely power coupling between one or more combinations of the power transmitting elements 214, and selecting the charging power transmitting elements comprises selecting two or more power transmitting elements such that each selected is an actuated power transmitting element, a well-coupled power transmitting element or a likely well-coupled power transmitting element, or both an actuated power transmitting element and a well-coupled power transmitting element or likely well-coupled power transmitting element. Thus, power transmitting elements that provide or are likely to provide a substantially uniform field about the receiver 18 may be chosen to be charging power transmitting elements, in addition to other single power transmitting elements and/or other combinations of power transmitting elements. Further, the set of charging power transmitting elements may be actuated and the set of charging power transmitting elements either reduced or augmented. The reduced or augmented set of charging power transmitting elements may be retained as the charging power transmitting elements, e.g., if the reduced/augmented set provides more power and/or more efficient power to the receiver 18 than the non-reduced/non-augmented set of charging power transmitting elements.

At stage 60, the method 50 includes charging the device wirelessly using the one or more charging power transmitting elements. For example, the power transmitting elements 214₃ and 214₄ may be actuated as charging power transmitting elements to charge the receiver 18. The controller 26 may cause the charging power transmitting elements, e.g., the power transmitting elements 214₃, 214₄ to be de-actuated in response to the receiver 18 being fully charged. For example, the controller 26 may de-actuate the charging power transmitting elements if the receiver 18 is fully charged and has a low present current draw, e.g., less than a threshold current draw. Further, the controller 26 may be configured to re-actuate the charging power transmitting elements 214 in response to one or more criteria such as battery capacity of the receiver 18 dropping below a threshold amount, e.g., 90% of total capacity, or 50% of total capacity, or another threshold.

Alternative and Example Configurations and Uses

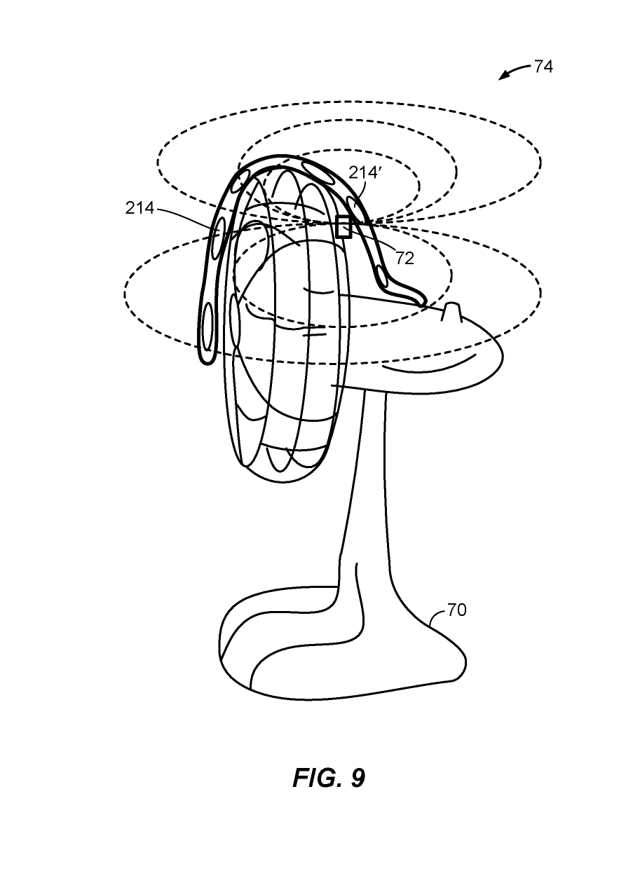

Various configurations of wireless power transmitter systems according to the disclosure are possible and may be put to a variety of uses. For example, the wireless power transmitter system 12 may be used as a charging blanket for an oddly-shaped receiver. Referring to FIG. 9, with further reference to FIG. 5, the power delivery structure 20 (shown in cut-away) may be placed over an oddly-shaped receiver, here a fan 70, that contains a receiver 72. The controller 26 may determine charging power transmitting elements from the power transmitting elements 214 and actuate the charging power transmitting elements to produce a magnetic field 74 to charge the receiver 72. Other oddly-shaped receivers may be charged including, but not limited to, toys, tools, and wearables. The power transmitting system may be configured as various objects including, but not limited to, a blanket, an article of clothing, a container (e.g., a bag, backpack, etc.), a seatcover, tablecloth, appliance cover, or placemat.

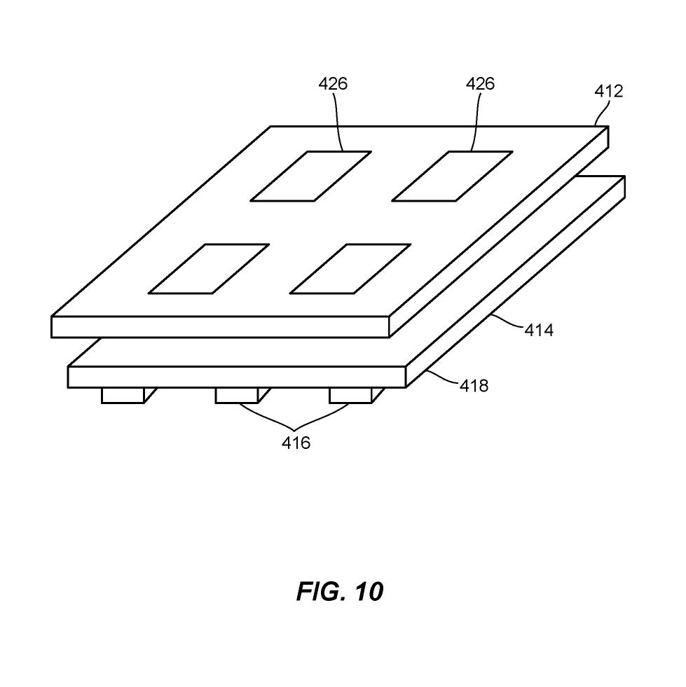

Referring to FIG. 10, another example of an implementation and application of a power transmitting system 412, similar to the power transmitting system 12, has the system 412 disposed over an organic light-emitting diode (OLED) display 414. The OLED display 414 includes flexible power transmitting elements 416 disposed on an opposite side of a substrate 418 as the OLEDs. The power transmitting system 412, including power transmitting elements 426, in conjunction with the power transmitting elements 416 may be used to charge one or more batteries (e.g., lithium-ion batteries) of the OLED display 414, with the system 412 and the display 414 flat, or rolled up, or in another shape. The system 12 may be integrated into a cover or case that may protect the display 414. The display 414 may fit inside such a cover or case.

Power Transmitting Element Connections

Various configurations may be used for connecting power transmitting elements in a power transmitting system to provide power to the power transmitting elements. For example, power transmitting elements retained by a flexible retention structure may be connected, e.g., to one side of the retention structure, to allow the retention structure to be cut to a desired size and/or shape, e.g., based upon a desired use, such as to accommodate the size and shape of a tabletop. The connections may be formed such that cutting of the retention structure is permitted upon specific boundaries, preferably selected to avoid cutting through a power transmitting element. An edging or binding mechanism such as tape may be used to inhibit or prevent exposure of or access to power conductors retained by the retention structure.

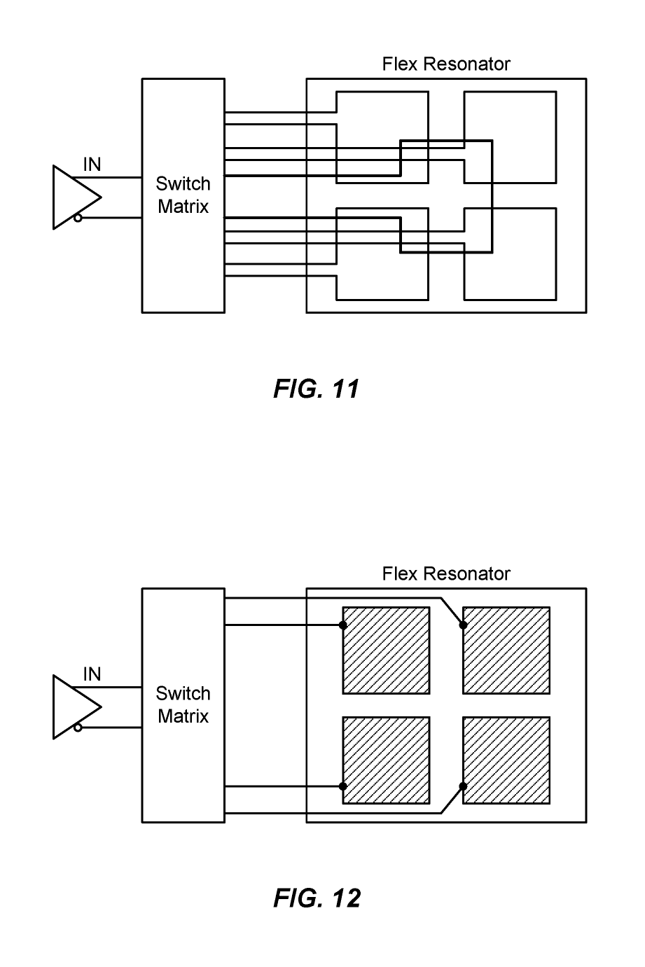

As an example of power transmitting element connections, connections of power transmitting elements may be made to a switch matrix. Referring to FIGS. 11-12, connections for the power transmitting elements are preferably brought to an edge of the retention structure and connected to a switch matrix that is configured to selectively actuate any single power transmitting element, or combination of power transmitting elements. In a configuration with inductive power transmitting elements, such as shown in FIG. 11, the power transmitting elements may be connected in series or in parallel. In a configuration with capacitive power transmitting elements, such as shown in FIG. 12, active plates are connected to a common feed point.

As another example of power transmitting element connections, power transmitting elements may be connected using cross-point switches. Referring to FIG. 13, cross-point switches are provided at each conductive intersection of a grid of rows and columns. The switches permit connection between the corresponding row and the corresponding column. Thus, arbitrary-sized (within the size of the provided grid) loop structures may be produced under control of a controller. In FIG. 13, triangles are open cross-point switches, circles are closed cross-point switches, and the heavy line shows a loop formed by the closed cross-point switches and conductive fibers connecting the closed cross-point switches.

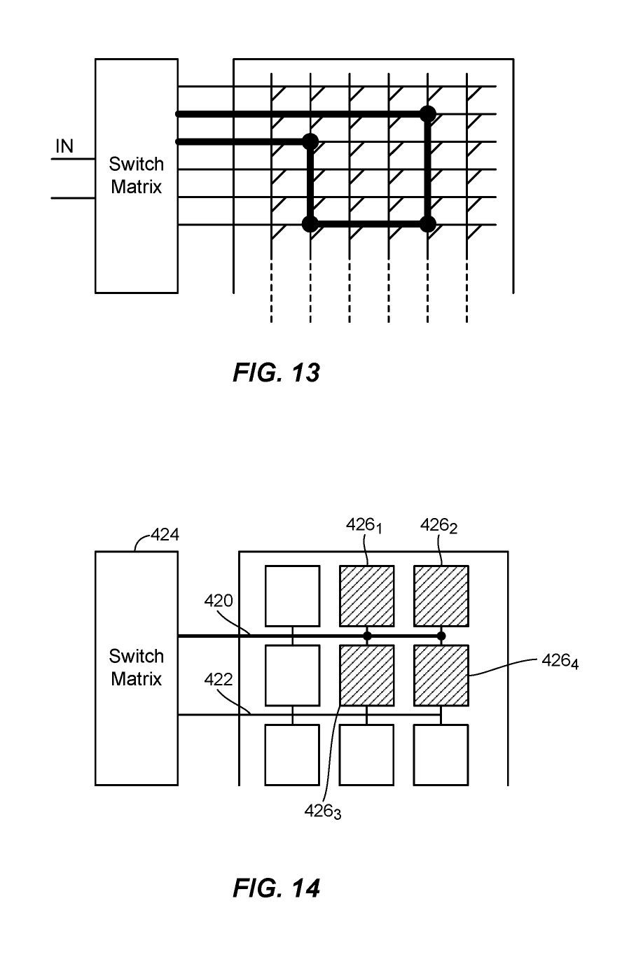

As yet another example of power transmitting element connections, power transmitting elements may be formed by connecting adjacent capacitive areas with switches. This allows arbitrarily-large capacitor plates (within size limitations of the provided set of conductive areas) to be produced under control of a controller. Referring to FIG. 14, conductive fibers 420, 422 extend from a switch matrix 424 between conductive plates 426 and are selectively connected to the plates 426 by switches 428. In the example shown in FIG. 14, plates 426₁, 426₂, 426₃, 426₄ are connected to the conductive fiber 420 by the appropriate switches being closed.

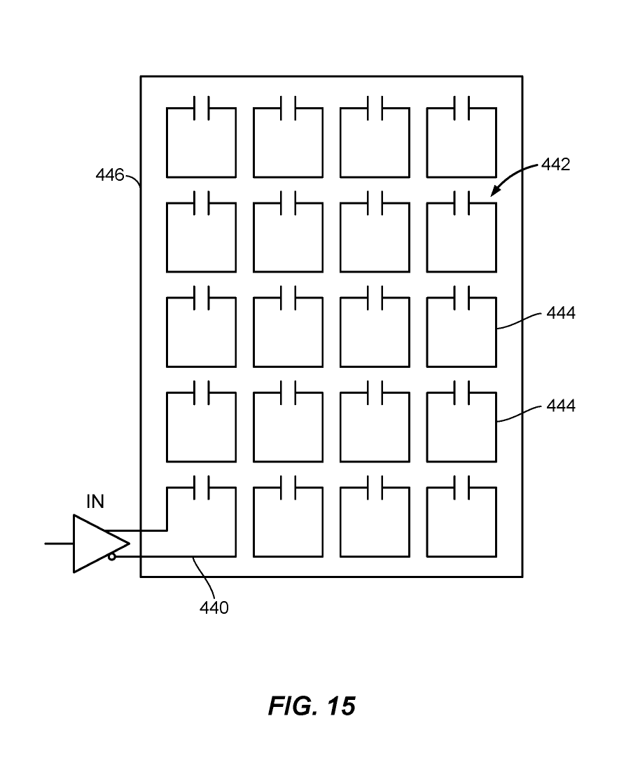

As yet another example of power transmitting element connections, an array of repeaters are connected to a single transmitter. Referring to FIG. 15, a single driving power transmitting element 440 is coupled to an array 442 of passive repeater power transmitting elements 444. The array may be retained by a flexible retention structure 446.

Power Receiving Systems

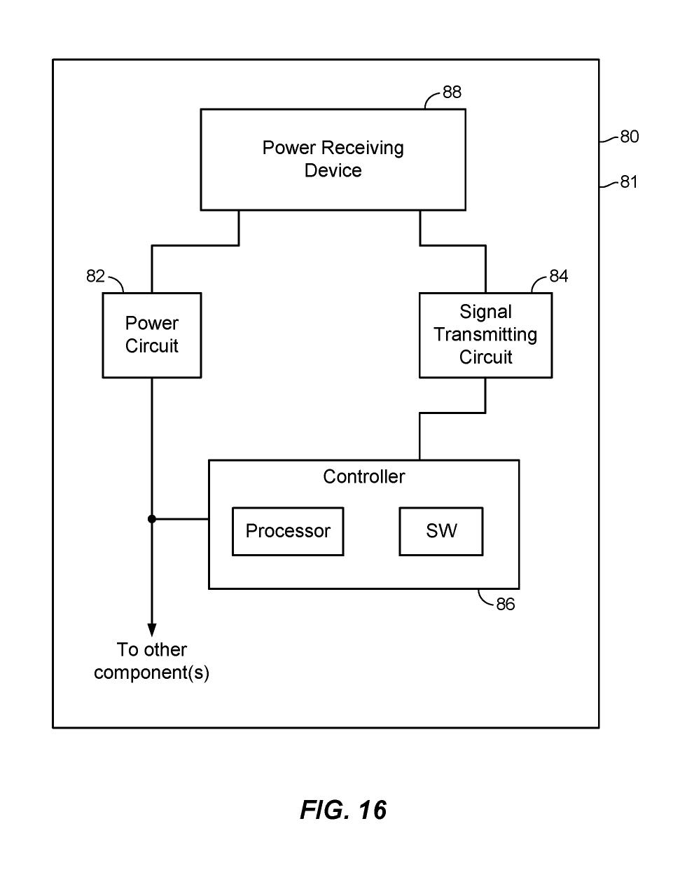

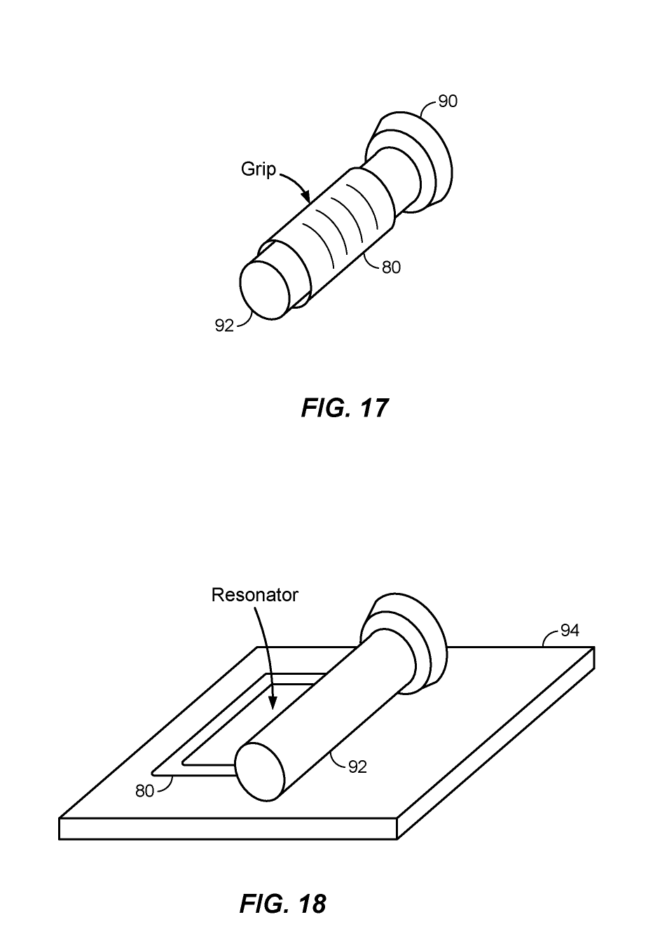

While the description above focused on the system 12 as a power transmitting system, a similar configuration may be used for receivers. That is, a flexible power reception structure may include one or more receiving elements, that may be similar to the power transmitting elements 214, and may be used to receive power wirelessly for a receiver. For example, referring to FIG. 16, a power receiving system 80 is configured similarly to the power transmitting system 12 shown in FIG. 5, but includes a retention structure 81, a power receiving circuit 82, a signal transmitting circuit 84, a controller 86, and a power receiving device 88 (that may include one or more power receiving elements). The power circuit 82 is configured to receive power from the power receiving device 88 and to provide the power to an electronic component of the receiver 18. The component may be, for example, a heart rate monitor, a battery, etc. The power circuit 82 may include rectification circuitry and circuitry for directing the power, e.g., to a battery or to another component. The signal transmitting circuit 84 is configured to send indications to a power transmitting system regarding power received by the power receiving device 88. The controller 86 is configured to monitor the power provided by the power circuit 82 and to drive the signal transmitting circuit 84. Referring to FIGS. 17-18, the power receiving system 80 may be part of an object, here a flashlight 90. As shown in FIG. 17, the power receiving device 80 is wrapped around a handle 92 of the flashlight 90, e.g., during transport by hand or use of the flashlight 90. As shown in FIG. 18, the power receiving device 80 is unwrapped/unfurled and extending away from the handle 92 and disposed on a charging platform 94 so that the power receiving system 80 may receive charging power from the charging platform 94.

Other Considerations

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

What is claimed is:

1. A wireless power transmitter system configured to charge a receiver wirelessly, the system comprising:
a power delivery structure comprising a plurality of power transmitting elements each of which is configured to induce a field while actuated, the power delivery structure being configured to adapt to an exterior shape of an entity that contains the receiver;
a power circuit communicatively coupled to the power transmitting elements and configured to provide power to the power transmitting elements selectively; and
a controller communicatively coupled to the power circuit and configured to:
determine an electrical characteristic, other than power transfer to the receiver, associated with actuating at least one power transmitting element of the plurality of power transmitting elements;
determine at least one power transmitting element subset based on the electrical characteristic, each of the at least one power transmitting element subset containing less than all, and at least one, of the plurality of power transmitting elements;
select, based on power transferred to the receiver from one or more of the at least one power transmitting element subset, one or more charging power transmitting elements from the one or more of the at least one power transmitting element subset to use to charge the receiver wirelessly; and
cause the power circuit to provide power to the one or more charging power transmitting elements to charge the receiver wirelessly.

2. The system of claim 1, wherein the controller is configured to:
determine the electrical characteristic by determining an impedance for each of the plurality of power transmitting elements; and
determine the at least one power transmitting element subset such that every power transmitting element of the at least one power transmitting element subset has an impedance that differs from a reference impedance by greater than a threshold amount.

3. The system of claim 2, wherein to determine the impedance the controller is configured to, for a respective power transmitting element of the plurality of power transmitting elements, determine a voltage and a current that are present in the respective power transmitting element while the respective power transmitting element is actuated.

4. The system of claim 2, wherein the reference impedance is an impedance of the respective power transmitting element without any object adjacent to the power delivery structure being close enough to the respective power transmitting element to affect the impedance of the respective power transmitting element significantly.

5. The system of claim 2, wherein the controller is configured to determine the reference impedance based on impedances of at least two of the plurality of power transmitting elements.

6. The system of claim 2, wherein the controller is configured to:
determine the at least one power transmitting element subset such that the at least one power transmitting element subset comprises a plurality of candidate power transmitting elements each having an impedance that differs from the reference impedance by greater than the threshold amount;
determine another electrical characteristic by determining power coupling between one or more combinations of the candidate power transmitting elements; and
select the one or more charging power transmitting elements by selecting one or more of the combinations of the candidate power transmitting elements such that every power transmitting element in every selected combination of the candidate power transmitting elements is an actuated power transmitting element, a well-coupled power transmitting element, or both, wherein each well-coupled power transmitting element is a power transmitting element that receives at least a threshold amount of power from one or more actuated power transmitting elements.

7. The system of claim 2, further comprising a plurality of three-dimensional magnetic sensors, wherein the controller is communicatively coupled to the three-dimensional magnetic sensors and is configured to:
determine the at least one power transmitting element subset such that the at least one power transmitting element subset comprises a plurality of candidate power transmitting elements each having an impedance that differs from the reference impedance by greater than the threshold amount;
determine another electrical characteristic by communicating with one or more of the three-dimensional magnetic sensors to determine one or more magnetic fields induced by actuating at least one of the candidate power transmitting elements; and
select the one or more charging power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

8. The system of claim 1, wherein:
the electrical characteristic comprises power coupling between two or more of the power transmitting elements; and
the controller is configured to select the one or more charging power transmitting elements by selecting two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements.

9. The system of claim 1, wherein:
the electrical characteristic comprises one or more magnetic fields induced by actuating the at least one power transmitting element; and
the controller is configured to select the one or more charging power transmitting elements by selecting two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

10. The system of claim 1, wherein the one or more charging power transmitting elements are one or more previously-selected charging power transmitting elements, the controller being further configured to:
actuate, after beginning to charge the device, a previously-unselected power transmitting element from the at least one power transmitting element subset; and
continue to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements.

11. The system of claim 1, wherein the at least one power transmitting element subset comprises at least two power transmitting element subsets, and wherein the controller is configured to select the one or more charging power transmitting elements by:
selectively actuating the two or more power transmitting element subsets at least one power transmitting element subset at a time;
determining power received by the device in response to selectively actuating the two or more power transmitting element subsets; and
selecting, as the one or more charging power transmitting elements, one or more of the two or more power transmitting element subsets corresponding to a highest amount of power coupled to the device.

12. A method of wirelessly charging a device, the method comprising:
actuating at least one power transmitting element of a plurality of power transmitting elements of a power delivery structure configured to adapt to an exterior shape of an entity that includes the device, each of the plurality of power transmitting elements being configured to induce a field while actuated;
determining an electrical characteristic, other than power transfer to the device, associated with actuating the at least one power transmitting element;
determining at least one power transmitting element subset based on the electrical characteristic, each of the at least one power transmitting element subset containing less than all, and at least one, of the plurality of power transmitting elements;
selecting, based on power transferred to the device from one or more of the at least one power transmitting element subset, one or more charging power transmitting elements from the one or more of the at least one power transmitting element subset to use to charge the device wirelessly; and
charging the device wirelessly using the one or more charging power transmitting elements.

13. The method of claim 12, wherein:
determining the electrical characteristic comprises determining an impedance for each of the plurality of power transmitting elements; and
determining the at least one power transmitting element subset comprises determining the at least one power transmitting element subset such that every power transmitting element of the at least one power transmitting element subset has an impedance that differs from a reference impedance by greater than a threshold amount.

14. The method of claim 13, wherein determining the impedance comprises, for a respective power transmitting element of the plurality of power transmitting elements, detecting a voltage and a current in the respective power transmitting element while the respective power transmitting element is actuated.

15. The method of claim 13, wherein the reference impedance is an impedance of the respective power transmitting element without any object adjacent to the power delivery structure being close enough to the respective power transmitting element to affect the impedance of the respective power transmitting element significantly.

16. The method of claim 13, wherein the reference impedance is based on impedances of at least two of the plurality of power transmitting elements.

17. The method of claim 13, wherein:
the at least one power transmitting element subset comprises a plurality of candidate power transmitting elements each having an impedance that differs from the reference impedance by greater than the threshold amount;
the method further comprises determining another electrical characteristic by determining power coupling between one or more combinations of the candidate power transmitting elements; and
selecting the one or more charging power transmitting elements comprises selecting one or more of the combinations of the candidate power transmitting elements such that every power transmitting element in every selected combination of the candidate power transmitting elements is an actuated power transmitting element, a well-coupled power transmitting element, or both, wherein each well-coupled power transmitting element is a power transmitting element that receives at least a threshold amount of power from one or more actuated power transmitting elements.

18. The method of claim 13, wherein:
the at least one power transmitting element subset comprises a plurality of candidate power transmitting elements each having an impedance that differs from the reference impedance by greater than the threshold amount;
the method further comprises determining another electrical characteristic by determining one or more magnetic fields induced by actuating at least one of the candidate power transmitting elements; and
selecting the one or more charging power transmitting elements comprises selecting power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

19. The method of claim 12, wherein:
the electrical characteristics comprise power coupling between two or more of the power transmitting elements; and
selecting the one or more charging power transmitting elements comprises selecting two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements.

20. The method of claim 12, wherein:
the electrical characteristics comprise one or more magnetic fields induced by actuating the at least one power transmitting element; and
selecting the one or more charging power transmitting elements comprises selecting two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

21. The method of claim 12, wherein the one or more charging power transmitting elements are one or more previously-selected charging power transmitting elements, the method further comprising:
actuating, after beginning to charge the device, a previously-unselected power transmitting element from the at least one power transmitting element subset; and
continuing to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements.

22. The method of claim 12, wherein the at least one power transmitting element subset comprises at least two power transmitting element subsets, and wherein selecting the one or more charging power transmitting elements comprises:
selectively actuating the two or more power transmitting element subsets at least one power transmitting element subset at a time;
measuring power received by the device in response to selectively actuating the two or more power transmitting element subsets; and
selecting, as the one or more charging power transmitting elements, the power transmitting element subset of the two or more power transmitting element subsets corresponding to a highest amount of power coupled to the device.

23. A wireless power transmitter system configured to charge a receiver wirelessly, the system comprising:
means for disposing a plurality of power transmitting elements (power transmitting elements), each of which is configured to induce a field while actuated, adjacent to and along a non-flat extent of an exterior of an entity that contains the receiver;
means for selectively actuating at least one power transmitting element of the plurality of power transmitting elements;
means for determining an electrical characteristic, other than power transfer to the device, associated with actuating the at least one power transmitting element;
means for determining at least one power transmitting element subset based on the electrical characteristic, each of the at least one power transmitting element subset containing less than all, and at least one, of the plurality of power transmitting elements; and
means for selecting, based on power transferred to the device from one or more of the at least one power transmitting element subset, one or more charging power transmitting elements from the one or more of the at least one power transmitting element subset to use to charge the device wirelessly.

24. The system of claim 23, wherein:
the means for determining the electrical characteristic comprise means for determining an impedance for each of the plurality of power transmitting elements; and
the means for determining the at least one power transmitting element subset are configured to determine the at least one power transmitting element subset such that every power transmitting element of the at least one power transmitting element subset has an impedance that differs from a reference impedance by greater than a threshold amount.

25. The system of claim 23, wherein:
the electrical characteristic comprises power coupling between two or more of the power transmitting elements; and
the means for selecting the one or more charging power transmitting elements comprise means for selecting two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements.

26. The system of claim 23, wherein:
the electrical characteristic comprises one or more magnetic fields induced by actuating the at least one power transmitting element; and
the means for selecting the one or more charging power transmitting elements comprise means for selecting two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

27. The system of claim 23, wherein the one or more charging power transmitting elements are one or more previously-selected charging power transmitting elements, the system further comprising:
means for actuating, after beginning to charge the device, a previously-unselected power transmitting element from the at least one power transmitting element subset; and
means for continuing to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements.

28. A non-transitory, processor-readable storage medium storing processor-readable instructions configured to cause a processor to:
actuate at least one power transmitting element of a plurality of power transmitting elements each of which is configured to induce a field while actuated;
determine an electrical characteristic, other than power transfer to the device, associated with actuating the at least one power transmitting element;
determine at least one power transmitting element subset based on the electrical characteristic, each of the at least one power transmitting element subset containing less than all, and at least one, of the plurality of power transmitting elements;
select, based on power transferred to the device from one or more of the at least one power transmitting element subset, one or more charging power transmitting elements from the one or more of the at least one power transmitting element subset to use to charge the device wirelessly; and
charge the device wirelessly using the one or more charging power transmitting elements.

29. The storage medium of claim 28, wherein:
the instructions configured to cause the processor to determine the electrical characteristic are configured to cause the processor to determine an impedance for each of the plurality of power transmitting elements; and
the instructions configured to cause the processor to determine the at least one power transmitting element subset are configured to cause the processor to determine the at least one power transmitting element subset such that every power transmitting element of the at least one power transmitting element subset has an impedance that differs from a reference impedance by greater than a threshold amount.

30. The storage medium of claim 28, wherein:
the electrical characteristic comprises power coupling between two or more of the power transmitting elements; and
the instructions configured to cause the processor to select the one or more charging power transmitting elements comprise instructions configured to cause the processor to select two or more of the power transmitting elements such that every charging power transmitting element is an actuated power transmitting element, a well-coupled power transmitting element, or both, wherein each well-coupled power transmitting element is a power transmitting element that receives at least a threshold amount of power from one or more actuated power transmitting elements.

31. The storage medium of claim 28, wherein:
the electrical characteristic comprises one or more magnetic fields induced by actuating the at least one power transmitting element; and
the instructions configured to cause the processor to select the one or more charging power transmitting elements comprise instructions configured to cause the processor to select two or more of the power transmitting elements such that every charging power transmitting element is either an actuated power transmitting element, a likely well-coupled power transmitting element, or both, wherein each likely well-coupled power transmitting element has an associated magnetic field, induced by one or more actuated power transmitting elements, that is determined to be (1) above a threshold intensity, or (2) within a directionality threshold of being parallel to an axis of the respective power transmitting element, or (3) a combination thereof.

32. The storage medium of claim 28, wherein the one or more charging power transmitting elements are one or more previously-selected charging power transmitting elements, the instructions further comprising instructions configured to cause the processor to:
actuate, after beginning to charge the device, a previously-unselected power transmitting element from the at least one power transmitting element subset; and
continue to charge the device using the previously-unselected charging power transmitting element in addition to the one or more previously-selected charging power transmitting elements based on power transferred to the device by the previously-unselected charging power transmitting element in addition to the one or more previously-selected charging power transmitting elements.
